(19) United States
(12) Patent Application Publication
(10) Pub. No.: US 2008/0031987 A1
(43) Pub. Date: Feb. 7, 2008

(54) Cotton candy making machine

(76) Inventor: Yuh-Hwai Huang, Tainan City (TW)

Correspondence Address: TROXELL LAW OFFICE PLLC;SUITE 1404, 5205 LEESBURG PIKE, FALLS CHURCH, VA, 22041, US

(21) Appl. No.: 11/497,361

(22) Filed: Aug. 2, 2006

(51) Int. Cl. B29B 9/00

(52) U.S. Cl. 425/8; 425/9

(57) ABSTRACT

A cotton candy making machine is provided. The cotton candy making machine allows sugar material to be outputted in a particular shape as desired. The cotton candy making machine includes a motor-driven rotary pot and a rotator, a material feeding tube disposed within said rotator, said material feeding tube distributing sugar material to said rotator, a shaping mold provided on said rotator, said shaping mold rotates freely relatively around said rotary pot, and a lifting mechanism driving said shaping mold or said rotary pot on a preset path back and forth when said rotary pot outputs sugar thread so as to make said sugar thread into a congregation with medium to high density inside said shaping mold.

### FIELD OF THE INVENTION

The present invention is related to a cotton candy making device; particularly, it is a device capable of allowing the output sugar material to be automatically formed into a preset shape of cotton candy that is a congregation with medium and high density.

### BACKGROUND OF THE INVENTION

In prior art, sugar material that is melted by heat generated in a high speed rotary pot and dissolved into liquid form is distributed out of the rotary pot through the holes formed on the rotary pot by the rotating centrifugal force. When the sugar material in liquid form contacts the cold air outside the rotary pot, thread-shape or fiber-like cotton candy is formed. This is a skill known in the art. For example, Taiwan patent number 7327380, titled “cotton candy making machine”, patent number 75210752, titled “cotton candy making device” provide an exemplary embodiment.

Prior art has disclosed a rotary pot that is provided with a slant angled output gap so that after sugar material is melted by heat in the rotary pot, it is expeditedly spinned out from the output gap; for example, patent number 78202635, titled “structural improvement of cotton candy shaping machine” provides a workable embodiment. As known by those skilled in the art, problems such as uneven heating, quality control of the cold air formed by the rotating leaves and cotton candy production still exist.

To improve the above problems, prior art has disclosed a multi-layered rotary pot device; for example, patent number 82206416, titled “improvement of cotton candy shaping machine” disclosed a metal net surrounded outside the multi-layered rotary pot device so as to separate the output sugar thread; a plurality of leaves are soldered on the rotary pot with equal angles so that when the leaves are rotated, downward wind force is formed to lead sugar thread; utilizing a triangular leading transport belt to flatten cotton candy; and a roller multi-cutter base used for cutting cotton candy into blocks. Alternatively, patent number 92205756, titled “structural improvement of the machine head of the cotton candy machine” disclosed a rotary pot that is provided with a tilted angled slot; the tilted angle of the slot corresponds to the tangent line of the centrifugal force generated by the rotation of the rotary pot so as to maintain the smoothness of producing sugar thread and prevent blockages on the holes of the rotary pot.

Prior art further disclosed a cotton candy making machine, utilizing a high speed driving axle of a high speed motor to drive the rotating axle of the large, small belt wheel to allow the rotating disc to generate fast rotation, thereby further improving the manufacturing efficiency and quality of the cotton candy; for example, patent number 87215148, titled “structural improvement of the cotton candy machine with automatic feeding material device” provides a workable embodiment.

Representatively speaking, these references showing the improvement of the cotton candy making machine, device or related structural skills have been granted patents. Conventional cotton candy making device or making machine tends to improve the rotary pot or rotary pot related structural assembly, and tends to provide cotton candy congregated with low density; if cotton candy making device is reconsidered for its design to have a different structure, it can improve a different usage from that of the prior art. For example, a structural design or technical means can produce cotton candy with different shapes or congregations with medium to high density; these subjects have not been disclosed in the prior patent applications.

### SUMMARY OF THE INVENTION

The primary object of the present invention is to provide a cotton candy making machine allowing output of the sugar material to automatically form a preset shape of cotton candy as desired. The present invention includes a motor-driven rotary pot and a rotator, a material feeding tube provided in the rotator, said material feeding tube is to distribute sugar material to the rotary pot, a shaping mold provided on the rotator, the shaping mold is relatively rotated freely around the rotary pot; and a lifting mechanism that drives the shaping mold or the rotary pot back and forth on a preset path when the rotary pot outputs sugar thread so as to form a congregation with medium to high density in the shaping mold.

In accordance with the cotton candy making machine, the shaping mold can be detached freely to be provided on the material feeding device; the shaping mold includes a rigid wall and an inner chamber defined by the rigid wall; the rigid wall has an inner surface defining a preset geometric shape of the inner chamber.

The rigid wall of the shaping mold may include a plurality of holes connected with the inner chamber; the holes may be connected to a vacuum pump through a leading tube so as to establish an air path and near a vacuum position, leading sugar thread to be attached to the inner surface of the rigid wall; and forming a congregation with high density.

In accordance with the cotton candy making machine of the present invention, a lifting mechanism drives the motor-driven rotary pot to move freely in the shaping mold chamber; allowing the rotary pot to distribute sugar thread to be evenly attached to every area of the inner surface of the rigid wall of the shaping mold.

In accordance with the cotton candy making machine of the present invention, a motor with a worm is provided on the worm wheel of the rotator so that the rotator may drive the shaping mode to rotate freely.

The novelty, characteristics, and other objects of the present invention can be better understood with the accompanying drawings; the drawings are as follows:

### DESCRIPTION OF THE DRAWINGS

FIG. 1 is a structural view of the present invention.

FIG. 2 is a schematic view of an operating embodiment of FIG. 1 illustrating a rotary pot distributing thread-shape or fiber-like cotton candy attached within a shaping mold chamber.

FIG. 3 is another operating embodiment of FIG. 1 showing the movement of the shaping mold and the distribution of the thread-shape or fiber-like cotton candy.

FIG. 4 is yet another operating embodiment of FIG. 1 disclosing the finishing product of the thread-shape or fiber-like cotton candy and the opening position of the shaping mold.

FIG. 5 is another structural embodiment of the present invention illustrating the shaping mold defining chambers of different shape at the same time.

FIG. 6 is a schematic operating embodiment of FIG. 5 disclosing the lifting mechanism allowing the horizontal portion to relatively drive the movement of the motor and the rotary pot within the shaping mold chamber.

FIG. 7 is another modified embodiment of the present invention illustrating the position of the shaping mold and the vacuum pump.

FIG. 8 is another structural embodiment of the present invention illustration the relative movement of the rotary pot and the shaping mold at the same time.

FIG. 9 is yet another structural embodiment of the present invention showing the structural relationship of the motor driving the shaping mold.

FIG. 10 is a schematic view of the operating embodiment of FIG. 9 illustrating the distribution of the cotton candy or the like within the shaping mold.

### DETAILED DESCRIPTION OF THE EMBODIMENTS

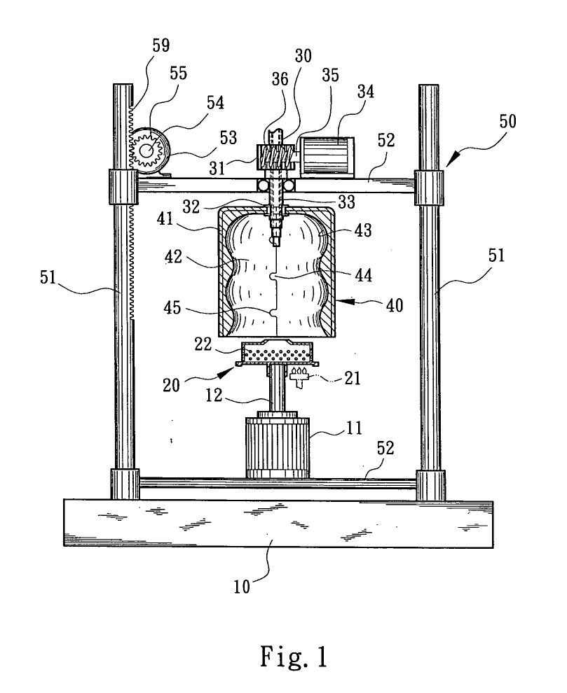

Refer to FIG. 1. In the preferred embodiment, the cotton candy making machine of the present invention includes a base 10, a lifting mechanism 50 and a motor 11 disposed on the base 10 or the lifting mechanism 50; the motor 11 has a main axle 12 that drives a rotary po 20 which receives heat from a heating device 21 (as shown in dotted line). The heating device 21 may also be selectively disposed in the rotary pot 20 utilizing an electric heating wire. The rotary pot 20 has a plurality of holes 22 so as to distribute sugar material that is melted into liquid form to the rotary pot 20. A rotator 30 provided with a shaping mold 40 is disposed on top of the rotary pot 20 and driven by a motor 34; the motor 34 has a driving axle 35 and a worm 36 thereon. The worm 36 is provided on the driving axle 35. The worm 36 is engaged with a gear wheel or a worm wheel 31 provided on the rotator 30 so that the rotator 30 and the shaping mold 40 may be driven by the motor driving axle 35 to rotate freely. The rotator 30 is in hollow shape so as to dispose a flexible material feeding tube 33 for automatically feeding materials or for manually distributing sugar material to the rotary pot 20. A lifting mechanism 50 provided on the base 10 may drive the rotator 30 and the shaping mold 40 back and forth on a preset path.

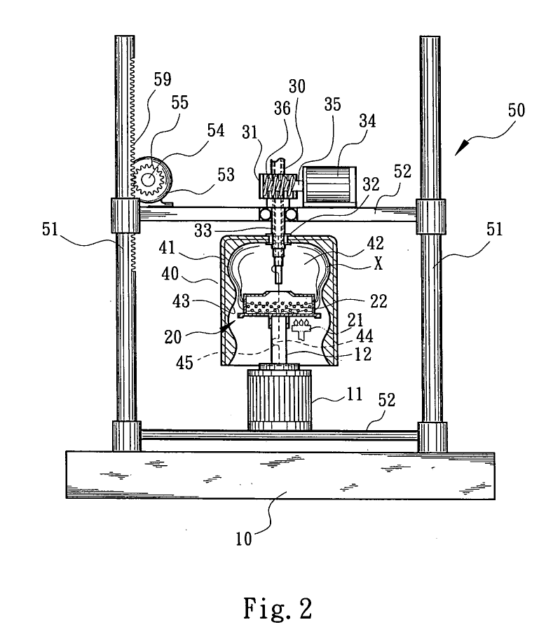

In one preferred embodiment, the lifting mechanism 50 includes a vertical portion 51 and a horizontal portion 52 capable of adjusting a relative position on the vertical portion 51. A motor 53 is installed on the horizontal portion 52. The lifting mechanism 50 includes a driving axle 54 and a gear wheel 55 fixed at a front end of the driving axle. In relation to the gear wheel 55 at the front end of the driving axle 54, the vertical portion 51 of the lifting mechanism 50 has a gear wheel or a gear structure 59 engaged with the gear wheel 55; as a result, when the motor driving axle 54 drives the gear wheel 55 to rotate, the horizontal portion 52 may relatively drive the motor 34, the rotator 30 and the shaping mold 40 into a movement along an axle direction, thereby causing rising and lowering movements, as shown in FIG. 2.

FIG. 1 also illustrates the rotator 30 with a fixing portion 32 that is pivotally connected to the shaping mold 40 such that the shaping mold 40 is generally surrounded around the rotary pot 20; the shaping mold 40 includes a rigid wall 41 and an inner chamber 42 defined by the rigid wall 41; rigid wall 41 has an inner surface 43 defining the inner chamber 42 into a preset geometric shape. In the preferred embodiment of the present invention, the shaping mold 40 tends to be selected from transparent materials such as glass, plastic or from non-transparent material such as metal; additionally, the shaping mold 40 has symmetrical flange 44 and tenon hole 45 so as to be detached freely and be disposed on the fixing portion 32 of the material feeding device 30. In another embodiment, the symmetrical shape of the shaping mold 40 can also be achieved by utilizing engaging device or the like.

Refer to FIG. 2. When sugar material is fed into the rotary pot 20 through the material feeding tube 33 of the rotator 30, sugar material is melted by heat through the fast speed rotation in the rotary pot 20 and dissolved into liquid form, as known in the prior art, sugar material is distributed out of the rotary pot 20 from the holes 22 on the rotary pot 20 by the centrifugal force; when sugar material in liquid form contacts cold air outside the shaping mold chamber 42 of the rotary pot 20, it is formed into a thread-shape or fiber-like cotton candy χ, attaching on the inner surface 43 of the rigid wall of the shaping mold 40 in rotating motion.

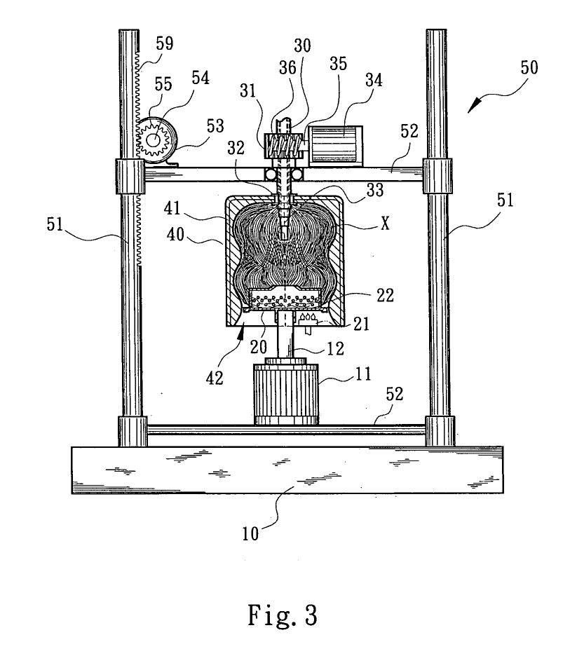

It is understood that the rotating direction that the motor 34 drives the rotator 30, shaping mold 40 via the worm 36 is the same or opposite of the rotating direction that the motor 11 drives the rotary pot 20 to rotate. Meanwhile, at this stage, the motor driving axle 54 of the lifting mechanism 50 rises and lowers the material feeding device 30 and the shaping mold 40 in an axle direction through the gear wheel 55 driving the gear wheel or the gear structure 59 on the vertical portion 51, thereby allowing the thread-shape or fiber-like cotton candy χ to uniformly and closely attached to the shaping mold chamber 42 forming a congregation with medium to high density, as shown in FIG. 3.

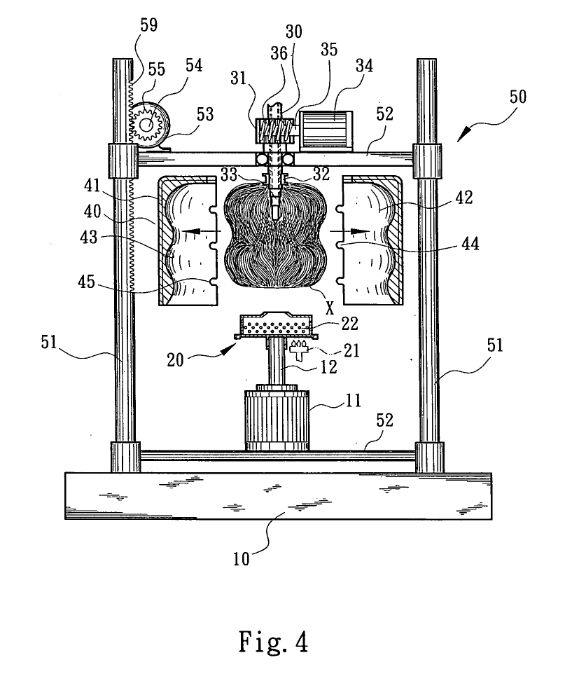

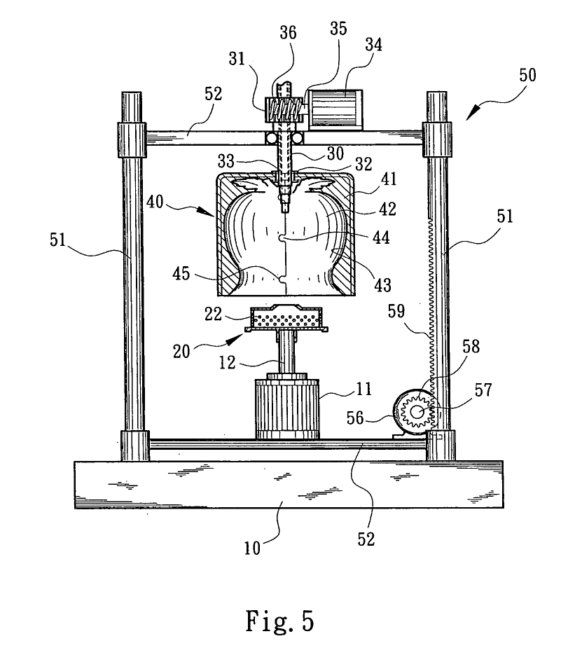

Refer to FIG. 4. When the shaping mold 40 finish molding the thread-shape or fiber-like cotton candy χ, the lifting mechanism 50 relatively moves the shaping mold 40 to the top of the figure by the motor 53 driving the gear wheel or gear structure 59 on the vertical portion 51, thereby allowing a user to open the shaping mold 40 and take out the finishing product of the cotton candy χ. Therefore, in the preferred embodiment of the present invention, the inner surface 43 of the rigid wall of the shaping mold 40 may define different chamber 42 shapes, as the chamber 42 shown in FIG. 5, allowing the consumer to select different molding shapes for the cotton candy χ.

Refer to FIG. 5 which shows another embodiment of the present invention. The present invention includes a base 10, a lifting mechanism 50 and a motor 11 provided on the base 10 or the lifting mechanism 50; the motor 11 has a main driving axle 12 to drive a rotary pot 20 that receives the heat from a heating device (not shown). The rotary pot 20 has a plurality of holes 22 thereon so as to allow the sugar material that is melted into liquid form to be distributed to the rotary pot 20. A rotator 30 provided for the shaping mold 40 is disposed on top of the rotary pot 20 and driven by a motor 34; the motor 34 has a driving axle 35 and a worm 36 on the driving axle 35. The worm 36 is engaged with a gear wheel or a worm wheel 31 provided on the rotator 30 so that the rotator 30 and the shaping mold 40 may be driven by the motor driving axle 35 to rotate freely. The rotator 30 is in hollow shape so as to dispose a flexible material feeding tube 33 for automatically feeding materials or for manually distributing sugar material to the rotary pot 20. A lifting mechanism 50 provided on the base 10 may drive the motor 11 and the rotary pot 20 back and forth on a preset path.

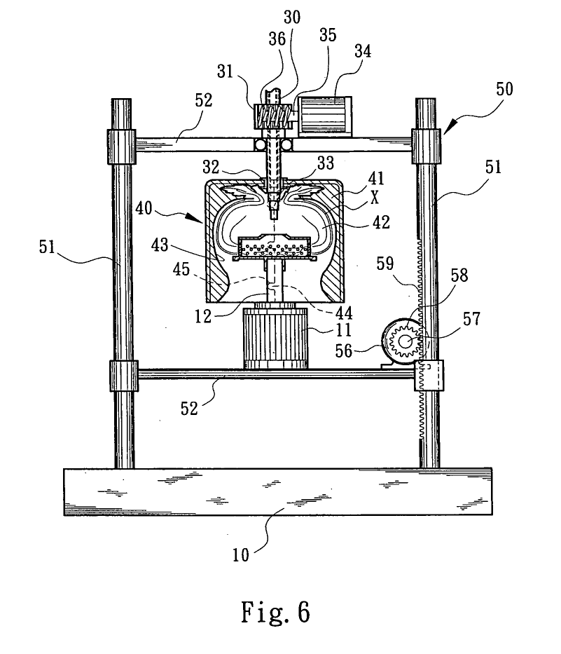

In one preferred embodiment, the lifting mechanism 50 includes a vertical portion 51 and a horizontal portion 52 capable of adjusting a relative position on the vertical portion 51. A motor 56 is installed on the horizontal portion 52. The lifting mechanism 50 has a driving axle 57 and a gear wheel 58 fixed at the front end of the driving axle 57. In relation to the gear wheel 58 at the front end of the driving axle 57, the vertical portion 51 of the lifting mechanism 50 has a gear wheel or a gear structure 59 engaged with the gear wheel 58; as a result, when the motor driving axle 57 drives the gear wheel 55 to rotate, the horizontal portion 52 may relatively drive the motor 11 and the rotary pot 20 into a movement along an axle direction in the chamber 42 of the shaping mold 40, thereby causing rising and lowering movements, as shown in FIG. 6.

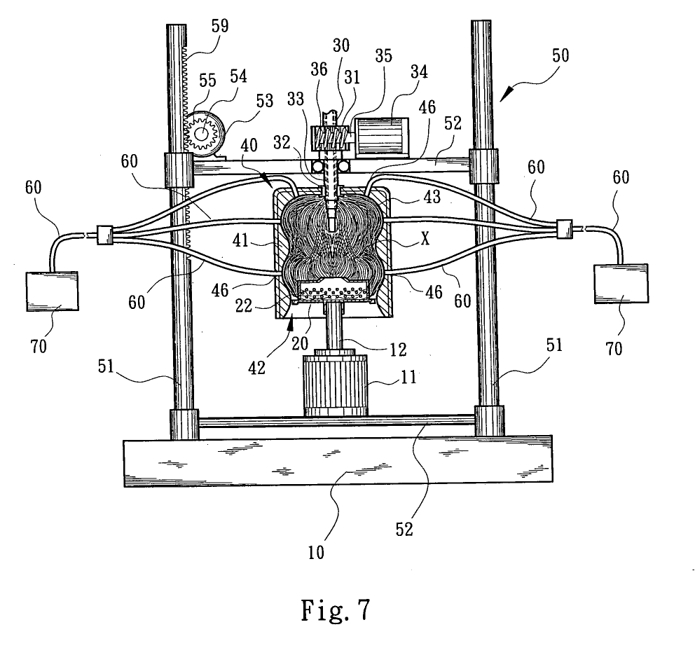

Refer to FIG. 7 which discloses an modified embodiment of the shaping mold 40 in accordance with the present invention; the rigid wall 41 of the shaping mold 40 as shown further includes a plurality of holes 46 connected to the inner chamber 42; the holes 46 are connected to a vacuum pump 70 via a leading tube 60 so as to establish an air path to take the air out of the chamber 42, thereby maintaining the chamber 42 in a nearly vacuum stage; meanwhile, the air flow and the vacuum stage may lead the thread-shape or fiber-like cotton candy χ produced by the rotary pot 20 into an appropriate position in the chamber 42, with the assistance of the centrifugal force created by the rotary pot 20, the thread-shape or fiber-like cotton candy χ is formed into a congregation with medium to high density attached to the inner surface 43 of the rigid wall.

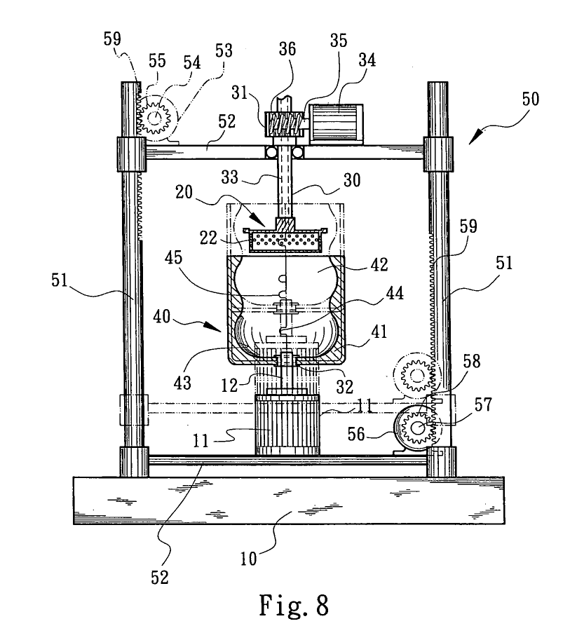

Refer to FIG. 8 which illustrates another embodiment of the present invention. The present invention includes a base 10, a lifting mechanism 50 and a motor 11 provided on the base 10 or the lifting mechanism 50; the motor 11 has a main axle 12 connected to the shaping mold 40 via the fixing portion 32 so as to drive the shaping mold 40 to rotate. The shaping mold 40 includes a rigid wall 41 and an inner chamber 42 defined by the rigid wall 41; the rigid wall 41 has an inner surface 43 defining the inner chamber 42 into a present geometric shape. A motor 34 provided on the lifting mechanism 50 has a main axle 35 that drives the rotary pot 20 which receives the heat from a heating device (not shown). The rotary pot 20 has a plurality of holes 22 to distribute sugar material that is melted into liquid form to rotary pot 20. In the preferred embodiment, the motor 34 has a driving axle 35 and a worm 36 on the driving axle 35. The worm 36 is engaged with a gear wheel or a worm wheel 31 provided on the rotator 30 so that the rotator 30 and the rotary pot 20 can be driven by the motor driving axle 35 to rotate freely. The rotator 30 is in hollow shape so as to dispose a flexible material feeding tube 33 for automatically feeding materials or for manually distributing sugar material to the rotary pot 20. A lifting mechanism 50 provided on the base 10 may drive the motor 11 and the shaping mold 40 or the motor 34 and the rotary pot 20 back and forth on a preset path.

In one preferred embodiment, the lifting mechanism 50 includes a vertical portion 51 and a horizontal portion 52 capable of adjusting a relative position on the vertical portion 51. A motor 56 is installed on the horizontal portion 52. The lifting mechanism 50 has a driving axle 57 and a gear wheel 58 fixed at a front end of the driving axle 57. In relation to the gear wheel 58 at the front end of the driving axle 57, the vertical portion 51 of the lifting mechanism 50 has a gear wheel or a gear structure 59 engaged with the gear wheel 58; as a result, when the motor driving axle 57 drives the gear wheel 55 to rotate, the horizontal portion 52 may relatively drive the motor 11 and the shaping mold 40 along an axle direction of the rotary pot 20, thereby causing rising and lowering movements, as shown by the imaginary portion in FIG. 8.

In a preferred embodiment, the imaginary portion in FIG. 8 also illustrates the motor 53 that is installed on the horizontal portion 52; it has a driving axle 54 and a gear wheel 55 fixed at the front end of the driving axle 54. In relation to the gear wheel 55 at the front end of the driving axle 54, the vertical portion 51 of the lifting mechanism 50 has a gear wheel or a gear structure 59 engaged with the gear wheel 55; as a result, when the motor driving axle 54 drives the gear wheel 55 to rotate, the horizontal portion 52 may relatively drive the motor 34, the rotator 30 and the rotary pot 20 into a movement along an axle direction in the chamber 42 of the shaping mold 40, thereby causing rising and lower movements.

The embodiment of FIG. 8 allows the motors 56, 53 to respectively drive the horizontal portion 52 so that the rotary pot 20 and the shaping mold 40 may create relative rising and lowering movements simultaneously; therefore, the user can operate the relative rising and lower movements of the rotary pot 20 and the shaping mold 40 so that the thread-shape or fiber-like cotton candy χ produced by the rotary pot 20 may enter into an appropriate position and density inside the shaping mold chamber 42. It is understood that the rotating direction that the motor 34 drives the rotator 30, rotary pot 20 via the worm 36 is the same or opposite of the rotating direction that the motor 11 drives the shaping mold 40 to rotate.

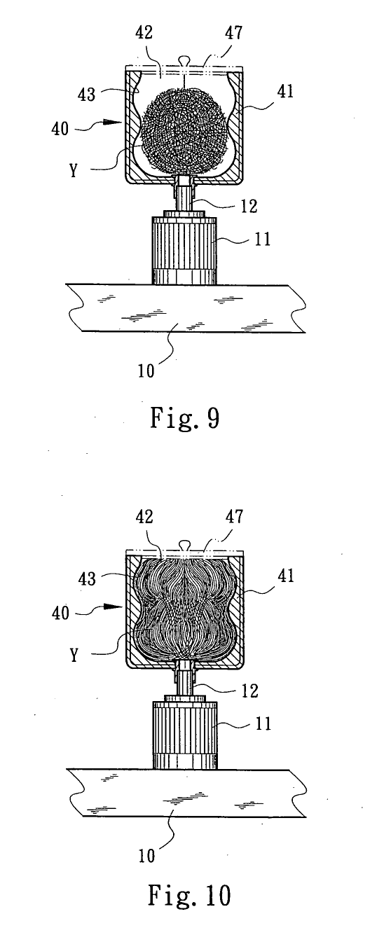

Refer to FIG. 9 which shows a derived embodiment of the present. The embodiment utilizes only the base 10 and the motor 11 provided on the base 10; the motor 11 has a main driving axle 12 to drive the shaping mold 40 to create centrifugal force. The shaping mold 40 includes a rigid wall 41 and an inner chamber 42 defined by the rigid wall 41; the rigid wall 41 has an inner surface 43 defining the inner chamber 42 in a preset geometric shape. In the preferred embodiment, the shaping mold 40 may include a lid 47 for closing the shaping mold 40.

FIG. 10 discloses a user manually positions cotton candy in a close to finished form or half finished product with low density or the like y in the chamber 42 of the shaping mold 40; when the motor 11 and the driving axle 12 allow the shaping mold 40 to rotate in high speed, the thread-shape cotton candy or the like y with low density is attached to the shaping mold chamber 42 by the centrifugal force, thereby forming cotton candy or the like y into a congregation with medium to high density with a present shape by the shaping mold 40. It is understood that the cotton candy or the like y may be selected in block structure; additionally, a plurality of cotton candy or the like y can be provided in the chamber 42 as desired.

What is to be explained is that the accommodation and the relative movement and the shaping mold 40 or the rotary pot 20 and the lifting mechanism 50 has at least the following conditions and advantages:
1. It allows the thread-shape or fiber-like cotton candy χ to automatically form into a congregation structure with medium to high density in the chamber 42 so that it can produce cotton candy with more ideal and better quality than the prior art.
2. It utilizes the shaping mold 40 to mold different shapes and forms of cotton candy, at the same time resolves the difficulty of using a stick to roll the sugar thread as the prior art and the monotone of the shape of the cotton candy.

Representively speaking, the cotton candy making machine provides an improved effect; the special form is different from that of the prior art, and has the functions not found in the prior art, thereby presenting a great improvement that should be granted with a patent.

However, the above described embodiment of the present invention is not meant to limit the scope of the present invention. Any modification to the claims and the equivalent thereof shall be within the spirit and scope of the present invention.

What is claimed is:

1. A cotton candy making machine, comprising:
a motor-driven rotary pot;
a rotatable rotator;
a shaping mold disposed on said rotator; and
a lifting mechanism, driving said rotator and shaping mold back and forth on a present path when said rotary pot outputs thread-shape or fiber-like cotton candy so as to make cotton candy into a congregation with medium to high density inside said shaping mold.

2. The cotton candy making machine of claim 1, wherein said rotator is disposed on top of said rotary pot, said rotator has a gear wheel or worm wheel, driven by a motor; said motor has a driving axle and a worm on said driving axle; said worm axle is engaged with said gear wheel or worm wheel on said rotator, such that said rotator and shaping mold are driven by said motor-driven axle, thereby rotating freely.

3. The cotton candy making machine of claim 1, wherein said rotator is provided in a hollow shape and a flexible material feeding tube is provided therein, so as to distribute sugar material to said rotary pot.

4. The cotton candy making machine of claim 1, wherein said lifting mechanism is disposed on a base.

5. The cotton candy making machine of claim 1, wherein said lifting mechanism includes a vertical portion and a horizontal portion capable of adjusting a related position thereof on said vertical portion;
a motor disposed on said horizontal portion, said motor has a driving axle and a gear wheel affixed on a front end of said driving axle; and
in relation to said gear wheel on said front end of said driving axle, said vertical portion has a gear wheel or gear structure engaged with said gear wheel, when said motor driven axle drives said gear wheel, said rotator and shaping mold can be relatively driven on a preset path or in an axle direction moving upwards.

6. The cotton candy making machine of claim 1, wherein said rotator has a fixing portion pivotally connected to said shaping mold such that said shaping mold is generally surrounded around said rotary pot.

7. The cotton candy making machine of claim 1, wherein said shaping mold includes a rigid wall and an inner chamber defined by said rigid wall; said rigid wall has an inner surface defining said inner chamber to form a particular geometric shape.

8. The cotton candy making machine of claim 1, wherein said shaping mold is symmetrically formed with a flange and a tenon whole, so as to be easily detached to be provided on an affixing portion on said material feeding tube.

9. The cotton candy making machine of claim 7, wherein said rigid wall of said shaping mold further comprises a plurality of holes connecting to said inner chamber; said holes can be connected to a vacuum pump via a leading tube, so as to establish an air path to suck out gas inside said chamber, allowing said chamber to remain close to a vacuum status.

10. A cotton candy making machine, comprising:
a motor-driven rotary pot and rotator;
a material feeding tube distributing sugar material to said rotary pot;
a shaping mold disposed on said rotator; and
a lifting mechanism driving said rotary pot back and forth on a preset path within said shaping mold when said rotary pot outputs thread-shaped or fiber-like cotton candy, so as to form cotton candy into a congregation with medium to high density inside said shaping mold.

11. The cotton candy making machine of claim 10, wherein said shaping mold further comprises a plurality of holes, connected to an inner chamber defined by said shaping mold said holes can be connected to a vacuum pump via a leading tube.

12. The cotton candy making machine of claim 10, wherein said rotator is disposed on top of said rotary pot, said rotator has a gear wheel or worm wheel driven by a motor; said motor has a driving axle and a worm on said driving axle; said worm is engaged with said gear wheel or worm wheel on said rotator, such that said rotator and shaping mold can be driven by said motor-driven axle, thereby rotating freely.

13. A cotton candy making machine, comprising:
a motor driven shaping mold;
said shaping mold comprising:
a rigid wall and an inner chamber defined by said rigid wall;
said rigid wall has an inner surface defining said chamber into a preset geometric shape.

14. The cotton candy making machine of claim 13, wherein at least one cotton candy or the like can be disposed inside said chamber of said shaping mold; when said motor drives said shaping mold to rotate, a congregation with medium to high density is formed with a present shape inside said chamber of said shaping mold.

15. The cotton candy making machine of claim 13, wherein said shaping mold includes a lid, sealing on said chamber of said shaping mold.

16. A cotton candy making machine, comprising:
a motor driven shaping mold;
a rotatable rotator;
a rotary pot disposed on said rotator; and
a lifting mechanism driving said rotary pot and shaping mold relatively back and forth on a preset path when said rotary pot outputs thread-shape or fiber-like cotton candy, so as to make said thread-shape or fiber-like cotton candy into a congregation with medium to high density within said shaping mold.

17. The cotton candy making machine of claim 16, wherein said motor has a driving axle and a worm on said driving axle; said worm is engaged with a gear wheel or worm wheel on said rotator, such that said rotator and rotary pot can be driven by said driving axle, thereby rotating freely.

18. The cotton candy making machine of claim 16, wherein said lifting mechanism includes a vertical portion and a horizontal portion capable of adjusting a relative position thereof on said vertical portion;
a motor, disposed on said horizontal portion, has a driving axle and a gear wheel affixed on a front end of said driving axle; and
in relation to said gear wheel on said front end of said driving axle, said vertical portion has a gear wheel or a gear structure engaged with said gear wheel, such that when said motor drives said driving axle to rotate said gear wheel, said rotator, rotary pot and shaping mold are relatively driven on a present path or in an axle direction moving upwards.
